(19) United States
(12) Patent Application Publication
(10) Pub. No.: US 2005/0254818 A1
(43) Pub. Date: Nov. 17, 2005

(54) Optical wireless access systems for train passengers

(75) Inventors: Feng Qing Zhou, San Jose, CA (US); Jonathan Yu Zhang, Cupertino, CA (US); Mark G. Reichenbach, Pleasanton, CA (US)

Correspondence Address: Bo-In Lin, 13445 Mandoli Drive, Los Altos Hills, CA, 94022, US

(73) Assignee: ZENTERA, INC. Limited

(21) Appl. No.: 11/021,669

(22) Filed: Dec. 23, 2004

Related U.S. Application Data
(63) Continuation-in-part of application No. 10/845,768, filed on May 14, 2004.

(51) Int. Cl. H04J 14/00

(52) U.S. Cl. 398/43; 709/249; 709/250

(57) ABSTRACT

A method for transmitting wireless signals from a plurality of wireless access points (AP) to a train is disclosed in this invention. The method includes a step of connecting a high speed wide-area local area network (WLAN) switch between a network and a multiplexed Ethernet fiber system for receiving and transmitting a plurality of Internet signals to the plurality of wireless access points (AP). The method further includes a step of implementing a wireless signal receiving and distribution system on the train for processing a roaming and handover from receiving the plurality of signals from one of the wireless access point to a next wireless access point. The method further includes a step of distributing the plurality of signals to a plurality of passenger-users traveling on the train.

This is a Continuous in Part Application (CIP) of a previously filed co-pending Application with Ser. No. 10/845,768 filed on May 14, 2004 by a co-inventor of this Application.

### FIELD OF THE INVENTION

This invention relates generally to optical wireless communication access systems. More particularly, this invention relates to the optical wireless communication access systems to allow passengers in a train to have network access without a requirement to manage complicate roaming processes for a large number of network users in a train when the train is continuously passing from one communication station to a next station.

### DESCRIPTION OF THE PRIOR ART

The network access and communications for the passengers in a train are faced with several technical difficulties. First of all, there are physical constraints for wireless signal transmission to the network users in a train especially when the train is passing through a subway where the wireless signals are most likely blocked due to the limitation of a narrow corridor where the wireless signal must pass through. Furthermore, as the train is continuously passing from one station to another, the wireless assess and communication system must manage a large number of roaming and handover processes when large number of network users in a train are also roaming from one train station to next station.

Therefore, a need still exists in the art of wireless access and network communication system design to provide a new system configuration and network access technology to enable the passengers in a train to conveniently and flexibly logon to a network without requiring the management of the complicate technical issues of continuous roaming and handover from one station to another involving a large number of network users.

### SUMMARY OF THE PRESENT INVENTION

It is therefore an object of the present invention to provide a novel system configuration and network access method to overcome the difficulties and limitations discussed above as now encountered in the conventional technologies.

Specifically, it is the object of the present invention to provide solution to the above-mentioned problems by integration of the fast wide local area network (WLAN) switch and the low cost multiplexed Ethernet over fiber transport system as well as the simplification of the handover configuration that treats train as a single entity and handles the clients on the train separately.

Briefly, in a preferred embodiment, the present invention discloses a networked communication system that includes a train station wireless distribution system for transmitting a plurality of wireless signals. The network communication system further includes a train wireless signal receiving and distribution system disposed on a train for receiving the plurality of signals from the train station wireless distribution system. The train station wireless distribution system further transmits the plurality of wireless signals includes multimedia contents. The networked communication system further includes a local area net hub/switch for receiving network signals for transmitting to the train station wireless distribution system. The networked communication system further includes a local area net (LAN) hub/switch connected to a wide-area local area network (WLAN) router for receiving network signals from an Internet network for transmitting to the train station wireless distribution system. The networked communication system further includes a central office (CO) server connected between and managing an interface between the LAN hub/switch and the train station wireless distribution system. The central office (CO) server connected to the train station wireless distribution system with an optical fiber. The central office (CO) server connected to the LAN hub/switch with an Ethernet cable. The networked communication system further includes at least a second train station wireless distribution system disposed in a second train station. The train wireless signal receiving and distribution system further includes a passenger signal distribution system for distributing the plurality of signals to a plurality of passenger-users traveling on the train. The train station wireless signal distribution system further includes a plurality of wireless access points each includes an antenna for transmitting the plurality of signals to the train wireless signal receiving and distributing system.

This invention discloses a networked communication system that includes a high speed wide-area local area network (WLAN) switch connected between a network and a multiplexed Ethernet fiber system for receiving and transmitting a plurality of Internet signals to the plurality of wireless access points (AP). The train further includes a wireless signal receiving and distribution system for processing a roaming and handover from receiving the plurality of signals from one of the wireless access point to a next wireless access point. The train wireless signal-receiving and distribution system further includes a passenger signal distribution system for distributing the plurality of signals to a plurality of passenger-users traveling on the train.

In summary, this invention discloses a method for transmitting a plurality of wireless signals to a train. The method includes a step of installing a train station wireless distribution system for receiving and transmitting a plurality of wireless signals and receiving the plurality wireless signals on the train. The method further includes a step of implementing a train wireless signal receiving and distribution system on the train for receiving the plurality of signals from the train station wireless distribution system. In a preferred embodiment, the step of transmitting the plurality of signals from the train station wireless distribution system further includes a step of transmitting the plurality of wireless signals including multimedia contents.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a functional block diagram for showing an overall architecture of a train information system includes a central office subsystem.

FIG. 2 is a functional block diagram for showing the wireless access for communications between the central office subsystem and the train station wireless distribution subsystem.

FIG. 3 is a functional block diagram for showing the wireless access and communication between the train station wireless distribution subsystem and the wireless station on a train.

FIG. 4 is a functional block diagram for showing the overall wireless access system and signal transmission between the central office subsystem, a train station wireless distribution subsystem, and the network users in multiple trains traveling to different directions;

FIG. 5A shows a WLAN system connection for providing multimedia data to train and subway train;

FIG. 5B shows the handover processes as the train passes from one wireless access node to next access node;

FIGS. 6A and 6B are functional block diagrams for illustrating the system connections and signal transmission paths from Internet to a train or subway train.

### DETAILED DESCRIPTION OF THE PREFERRED EMBODIMENT

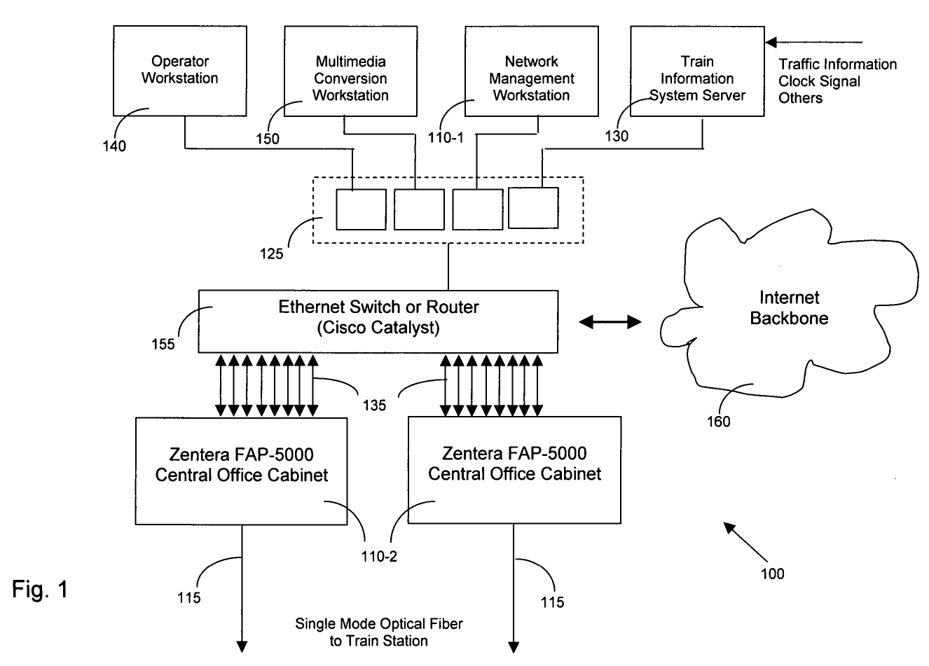

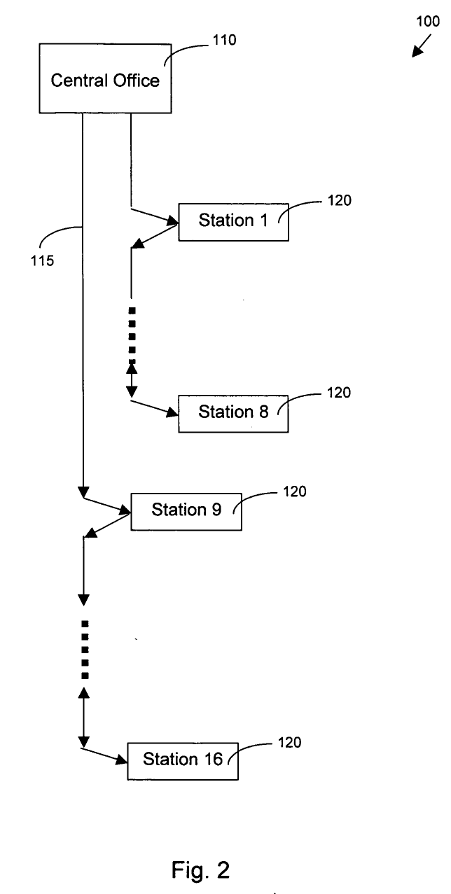

Referring to FIG. 1 for functional block diagram of a wireless access system 100 to provide passengers on a train, e.g., a subway train, wireless access to Internet. The wireless access system includes a central office subsystem 110 and a train station wireless distribution subsystem 120 (see FIG. 2). A single strand of a single mode optic fiber is connected between a central office 110 to multiple train station wireless distribution subsystem 120. For example in a preferred embodiment, a central office subsystem 110 can support eight train station wireless distribution subsystems 120, then for a subway line of thirty-two stations, four central office subsystems 110 are implemented to serve the train stations over the entire line.

Referring to FIGS. 1 and 2 for the architecture of a central office subsystem 110 to carry out a “data push” operation at the train station. The subsystem includes a network management workstation 110-1 connected to an Ethernet local area network hub/switch 125 to communicate with a train information system server 130 that provides the traffic information and clock signals. The network management workstation 110-1 also operates with a multimedia conversion workstation 140 and an operator workstation 150. The Ethernet LAN hub/switch 125 is connected to another Ethernet switch or router 155 to an Internet backbone infrastructure 160. The Ethernet switch or router 155 then interconnected with RJ45 Ethernet cables to multiple central office cabinet 110-2 and each central office cabinet 110-2 is in turn connected to multiple train stations via single strand single mode optical fibers 115.

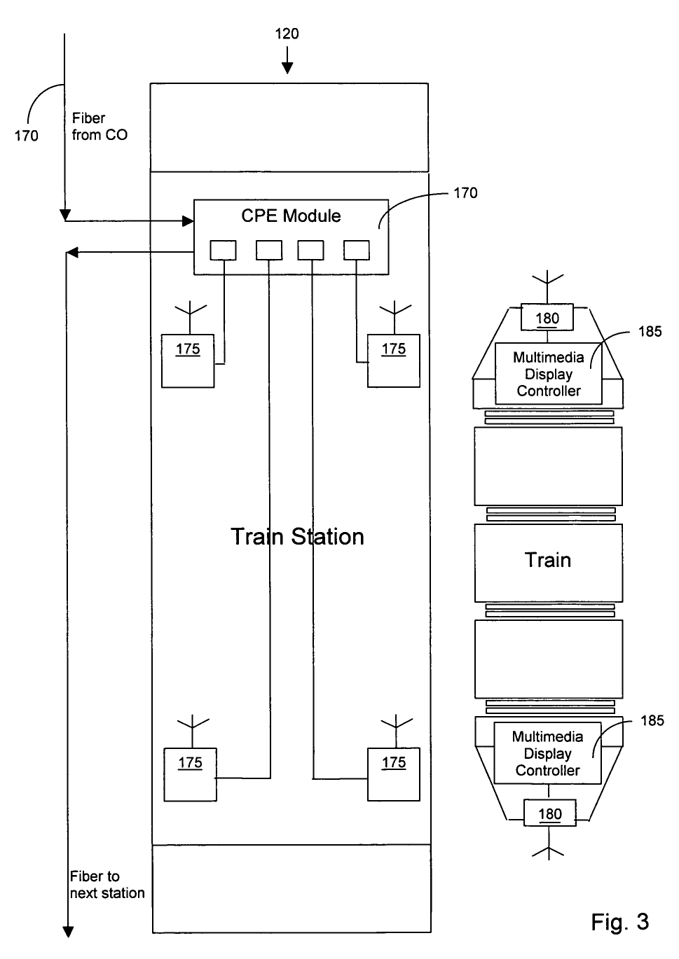

Referring to FIG. 3 for a functional block diagram for showing the architectural configuration of the train station wireless distribution subsystem 120. The train station wireless distribution system 120 includes a CPE module 170 to receive optical signals via the single strand single mode fiber 115. The CPE module 170 converts the optical signals into Ethernet signals and transmits these Ethernet signals via a four port Ethernet switch to four wireless access points 175. Each of these wireless access points 175 has an antenna to transmit wireless signals to a wireless station 180 on a train in a point to point communication mode. The wireless station 180 is connected to a multimedia display controller 185 where the multimedia information maybe edited and integrated for display. Thus the wireless access system as disclosed in this invention provides a transpacent transport connection between the Cisco router port, e.g., 100Base T Ethernet Port disposed on the CPE module 170, and the multimedia display controller 185 wherein the connection is a data link layer bridge between the router port and the multimedia display controller.

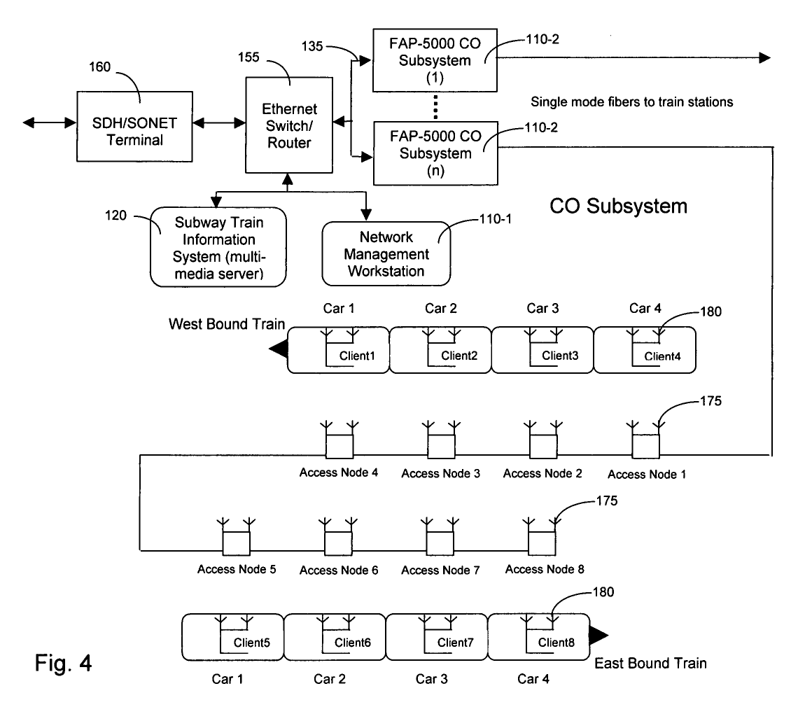

Referring to FIG. 4 for an overall architectural configuration of the wireless access system for the passengers traveling inside a train. The access system includes a central office (CO) cabinet 110-2 connected to an Ethernet switch router 155 via eight RJ45 Ethernet cables 135 wherein each cable has a bandwidth of 100M thus enabling the central office cabinet 110-2 to have a bandwidth up to 800M. The CO subsystem 11-2 then converts the signals into optical signals and transmits via optical fiber 115 to the train station wireless distribution subsystem 120. The optical signals received by the train station wireless distribution system 120 are first converted into electric signals. The train station wireless distribution 120 then sends out wireless signals through the access nodes 175 in each train station to the wireless stations 180 on the train and the wireless stations 180 then provides signals to individual clients in the cars of each train that may be traveling east bond or west bond.

By providing access nodes along the rail road in each train station for communicating with the wireless stations in the cars of the train, the configuration resolve the complicated problems of roaming where multiple passengers have to roam from one station to a next station as the train travel along the rail road. The roaming and hand-over from one access nodes 175 to another access node in next train station is managed only between the train station and the train instead of a large number of passengers. Each train is therefore managed as a single communication entity to interact with a linear series of access nodes disposed in each train station or at appropriate locations along the railroad. The wireless stations in the train are continuously in communication with either one or two access nodes. The wireless station 175 then distribute the signals to passengers either on wire or wireless communication to the wireless stations disposed on the car of the train.

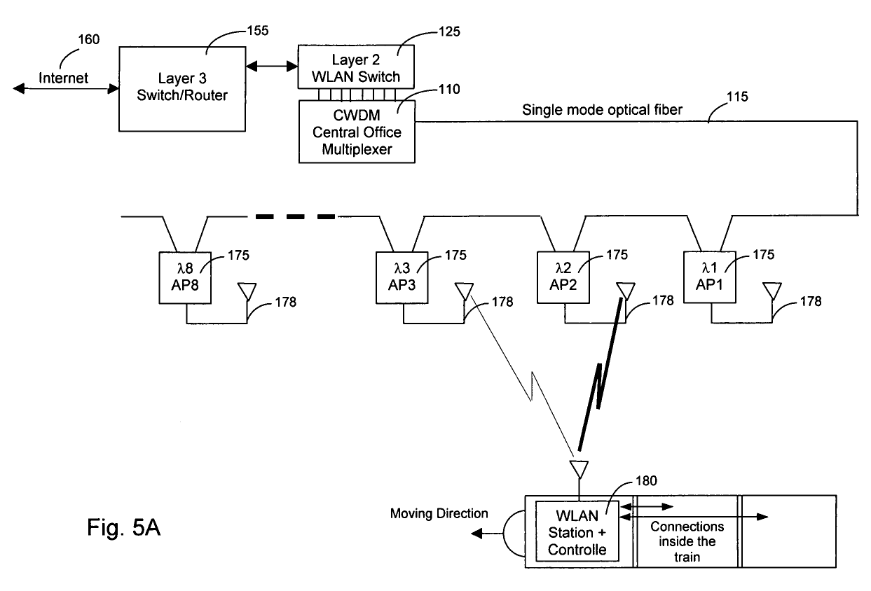

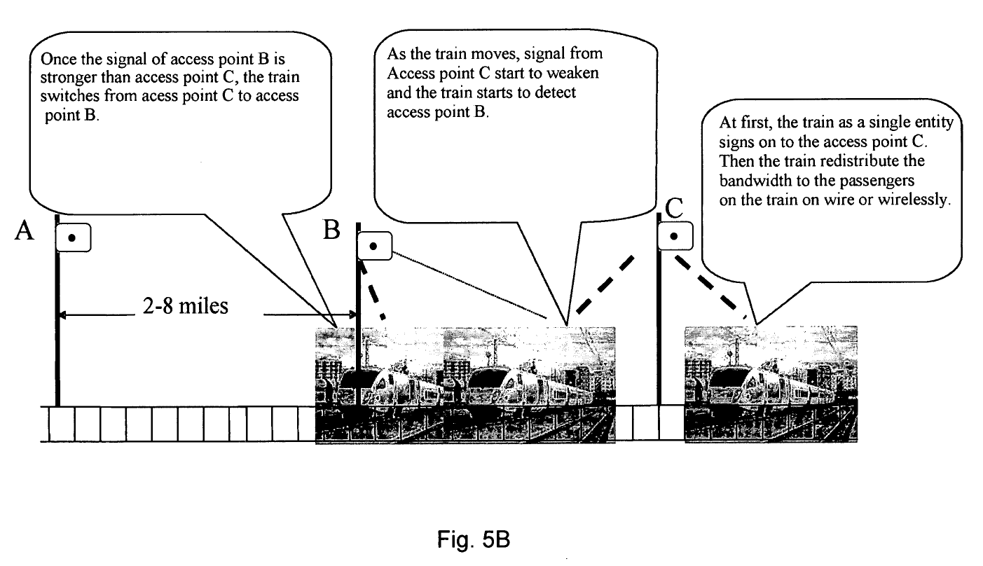

Referring to FIG. 5A shows the system structure of the real time WLAN Internet connectivity for train and subway train. The whole system comprises a layer-3 switch or router 155 that acts as a gateway for real time Internet connectivity of the train system. FIG. 5A represents the common configuration for most of the Internet connectivity systems. In this preferred embodiment, the Internet connectivity of the train system comprises a layer-2 WLAN switch 125. The WLAN switch 125 is connected to a CWDM central office multiplexer 110. Detail explanations for this equipment can be found in U.S. patent application entitled “Optical Wireless Access Systems” with application Ser. No. 10/845,768 and filed on May 14, 2004. Up to 16 channels of optical signals can be multiplexed into a single strand of fiber 115. The optical signals can transmit as far as 80 km. For train and subway applications, fiber cable usually runs along the railway track. Along the fiber route, individual channel of signal can be dropped. Signals from local can be added as well and to be transported to the central office. Thus a two-way communication is established. The add/drop node is integrated with a WLAN access point 175. The access point 175 is connected with an external antenna 178. An array of add/drop nodes can be arranged and aligned along the railway track. The wireless signal coverage of the access points 175 is overlapping with each other so that when a train travels along the track, it establishes a WLAN connectivity all the way along. At this system, the train is dealt with as one WLAN station. A controller 180 manages the connections inside the train connected or integrated with the WLAN station 180. The controller may run DHCP (dynamic host configuration protocol), NAT (network address translation) and connection tracking as well as various proxy functions. This way, the outside world does not need to know the details inside the train. The controller 180 handles the Internet sessions as it keeps tracking all the connections that are active. The WLAN switch 125 only needs to treat the train as a single entity and manages its AAA (authentication, authorization and accounting), connectivity as well as handoff from one AP to the other. The handoff protocol can be the IAPP (inter access point protocol) or other proprietary implementations (such as those from Aruba Networks, Airespace Networks, Trapeze Networks, etc.). Preferably, the AP and the WLAN switch initiate the handoff from one AP to the next AP instead of the station. Since the handoff sequence is predetermined in this particular application, the AP initiated handoff will be the fastest in time (around the range of 10 ms), which is good for voice over IP. The unique feature of this system is the integration of fast handoff WLAN switch and low cost optical multiplexed Ethernet transport system. The optical multiplexed Ethernet transport system can be any one of the embodiments described in above cited U.S. Patent application documentation FIG. 5B illustrates the process of hand-over from one access point (AP) to next AP 175 when the train is traveling from one AP to next AP, e.g., from point C to point A as that shown in FIG. 5B. At first the train is functioning as a single entity that signs on to the access point C. Then the train controller 180 redistributes the bandwidth to the passengers on the train who are connected to the controller 180 either by wires or wirelessly. As the train moves from point C to point B, the signals from the AP C start to become weaker and the train begins to detect the signals transmitted from the access point B. Once the signals from the access point B is stronger that the signals from the access point C, then the train controller 180 switch from access point C to access point B. With this system configuration, the train is managed as a single entity for signal transmission and handover processes. The train controller 180 as a single signal processing entity is interacting with a series of access points 175 along the route of traveling. At any point the train only interacts with two access points. The controller 180 on a train then redistributes the signals received from the access point 175 to each passenger either through wire or wirelessly. In addition to the signal strength, there are various handover criteria, such as signal noise ratio, communication data rate drop, the count of the lost packets, etc. Actually, in this particular application, the adjacent access points usually have no client at all, they can act as RF monitors to test the RF environments around them and make smart handover decisions via WLAN switch 125.

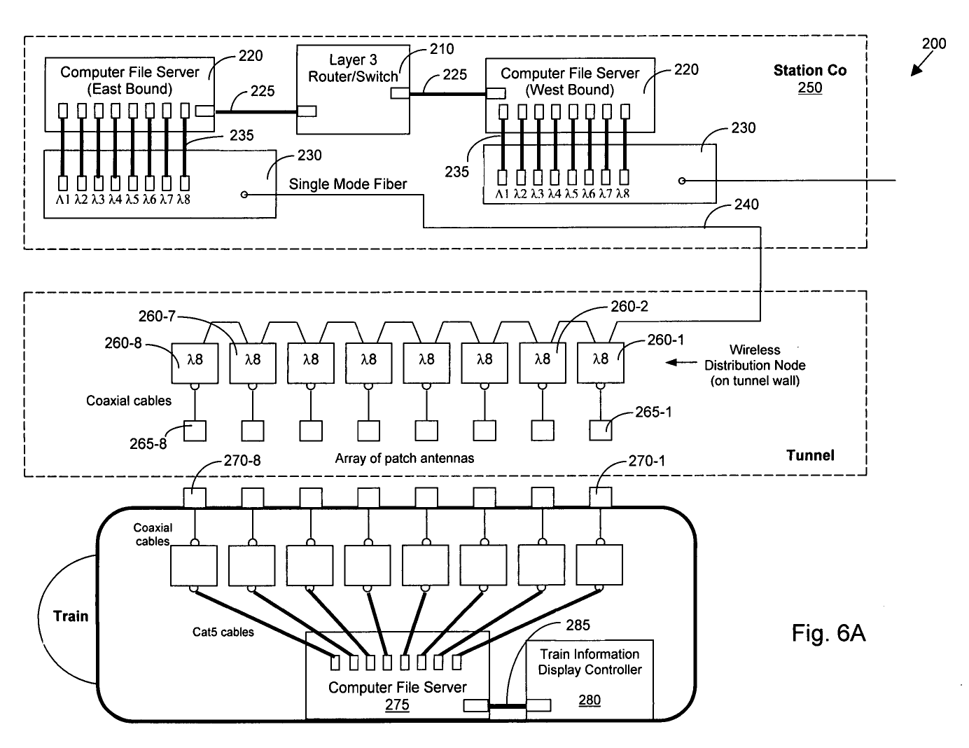

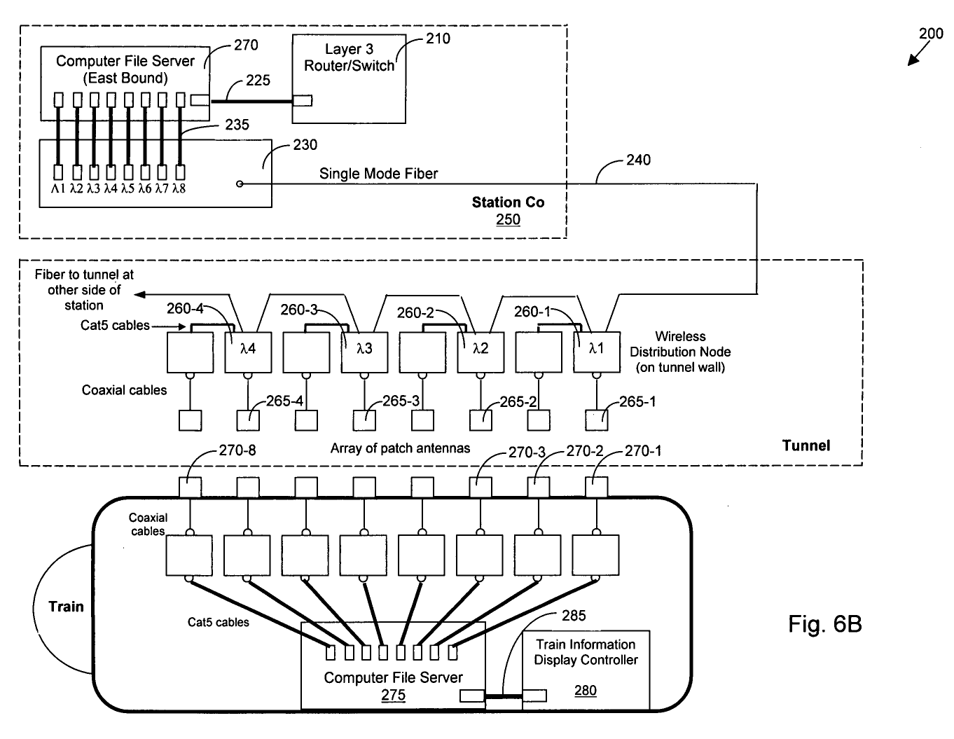

FIG. 6A shows a WLAN system 200 that pushes a great amount of data into a train 280 when it arrives at a train station. This multimedia information is available for transmission and display during the traveling of the train 280 from one station to the next. This system fits to subway train that does not require hard real time display of the information, but still needs information that pertinent to the train station and time sensitive news and other quasi real time information. The layer 3 switch or router 210 acts as a gateway to the outside internet world. Two computer servers 220 are connected to the router 210 as well as outside internet world via GigaE Ethernet 225. Two CWDM central office multiplexers 230 are connected with the computer servers via an array of 100 Mbps Ethernet cables 235. The two multiplexers are employed for data transmissions to the east bound and west bound trains separately. The multiplexed signals are transported via a single mode fiber 240 from the station control room to the station 250. There are eight add/drop nodes 260-1, 260-2, 260-3, . . . , 260-8, integrated with eight WLAN access points 265-1, 265-2, 265-3, . . . , 265-8, and connected with eight external antennas. On the train, there are also eight corresponding WLAN stations 270-1, 270-2, 270-3, . . . , 270-8, connected with external antennas. The number eight here does not have special meaning. Actually, the number is solely determined by the actual bandwidth requirement. These WLAN stations 270-1 to 270-8 are connected with another computer server 275 and again connected to the train information display controller 280 via a GigaE Ethernet 285. This arrangement forms eight WLAN point-to-point connections. The configuration as shown here provides an advantage that the aggregate bandwidth is greater than 200 Mbps when train stops at the station that is achievable through the application layer transmission. It is noted that even though each access point can achieve a raw bandwidth of 54 Mbps in the physical layer, the bandwidth in an application layer transmission is much lower due to considerable overhead that is required to compensate for the unreliable wireless transmissions. According to the configuration as shown in FIG. 6A, the data transmission in the WLAN system provides an aggregate bandwidth that is significantly greater than what can be normally achieved in the application layer through a conventional WALN system.

The system described in FIG. 6B is actually almost the same as in FIG. 6A. Since the WLAN bandwidth per channel can theoretically reach a maximum of only 54 Mbps half duplex and that is considerably less than the bandwidth of 100 Mbps in the full duplex mode that can be provided by the add/drop node can provide, FIG. 6B is implemented with less equipments to reach the same application layer aggregate bandwidth. Specifically, the WLAN system is implemented with four instead of eight add/drop nodes 260-1 to 260-4 at each side of the station. The system implements a three-port 100 Mbps Ethernet switch inside the add/drop node so that each add/drop node can feed two WLAN access points.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1. A networked communication system comprising:
a train station wireless distribution system for transmitting a plurality of wireless signals; and
a train wireless signal receiving and distribution system disposed on a train for receiving said plurality of signals from said train station wireless distribution system.

2. The networked communication system of claim 1 wherein:
said train station wireless distribution system further transmitting said plurality of wireless signals comprising multimedia contents.

3. The networked communication system of claim 1 further comprising:
a local area net hub/switch for receiving network signals for transmitting to said train station wireless distribution system.

4. The networked communication system of claim 1 further comprising:
a local area net (LAN) hub/switch connected to a wide-area local area network (WLAN) router for receiving network signals from an Internet network for transmitting to said train station wireless distribution system.

5. The networked communication system of claim 4 further comprising:
a central office (CO) server connected between and managing an interface between said LAN hub/switch and said train station wireless distribution system.

6. The networked communication system of claim 5 wherein:
said central office (CO) server connected to said train station wireless distribution system with an optical fiber.

7. The networked communication system of claim 5 wherein:
said central office (CO) server connected to said LAN hub/switch with an Ethernet cable.

8. The networked communication system of claim 4 further comprising:
at least a second train station wireless distribution system disposed in a second train station; and
a central office (CO) server connected between and managing an interface between said LAN hub/switch and said train station wireless distribution systems disposed in said train stations.

9. The networked communication system of claim 1 wherein:
said train wireless signal receiving and distribution system further comprising a passenger signal distribution system for distributing said plurality of signals to a plurality of passenger-users traveling on said train.

10. The networked communication system of claim 1 wherein:
said train station wireless signal distribution system further comprising a plurality of wireless access points each comprising an antenna for transmitting said plurality of signals to said train wireless signal receiving and distributing system.

11. A networked communication system for transmitting wireless signals from a plurality of wireless access points (AP) to a train comprising:
a high speed wide-area local area network (WLAN) switch connected between a network and a multiplexed Ethernet fiber system for receiving and transmitting a plurality of Internet signals to said plurality of wireless access points (AP).

12. The networked communication system of claim 11 wherein:
said train further comprising a wireless signal receiving and distribution system for processing a roaming and handover from receiving said plurality of signals from one of said wireless access point to a next wireless access point.

13. The networked communication system of claim 11 wherein:
said train wireless signal receiving and distribution system further comprising a passenger signal distribution system for distributing said plurality of signals to a plurality of passenger-users traveling on said train.

14. A networked communication system comprising:
at least a first and a second train station wireless distribution systems for transmitting a plurality of wireless signals; and
a train wireless signal receiving and distribution system disposed on a train for receiving said plurality of signals from at least one of said first and second train station wireless distribution systems wherein said train wireless signal receiving and distribution system further comprising a handover processor for processing a handover from receiving said plurality of signals from a one of said first and second train station wireless distribution systems to another of said first and second train station wireless distribution systems.

15. A networked communication system comprising:
at least a first and a second wireless access points for transmitting a plurality of wireless signals to a train; and
a train wireless signal receiving and distribution system disposed on a train for receiving said plurality of signals from at least one of said wireless access points wherein said train wireless signal receiving and distribution system further comprising a handover processor for processing a handover from receiving said plurality of signals from a one of said wireless access to another of said wireless access points.

16. A method for transmitting a plurality of wireless signals to a train comprising:
installing a train station wireless distribution system for receiving and transmitting a plurality of wireless signals and receiving said plurality wireless signals on said train.

17. The method of claim 16 further comprising:
implementing a train wireless signal receiving and distribution system on said train for receiving said plurality of signals from said train station wireless distribution system.

18. The method of claim 16 wherein:
said step of transmitting said plurality of signals from said train station wireless distribution system further comprising a step of transmitting said plurality of wireless signals including multimedia contents.

19. The method of claim 16 further comprising:
implementing a local area network (LAN) hub/switch for receiving network signals for transmitting to said train station wireless distribution system.

20. The method of claim 16 further comprising:
connecting a local area network (LAN) hub/switch to a wide-area local area network (WLAN) router for receiving network signals from an Internet network for transmitting to said train station wireless distribution system.

21. The method of claim 20 further comprising:
connecting a central office (CO) server between said LAN hub/switch and said train station wireless distribution system for managing an interface between said LAN hub/switch and said train station wireless distribution system.

22. The method of claim 21 further comprising:
connecting said central office (CO) server to said train station wireless distribution system with an optical fiber.

23. The method of claim 21 further comprising:
connecting said central office (CO) server to said LAN hub/switch with an Ethernet cable.

24. The method of claim 20 further comprising:
disposing at least a second train station wireless distribution system in a second train station; and
connecting a central office (CO) server between said LAN hub/switch and said train station wireless distribution systems disposed in said train stations.

25. The method of claim 17 further comprising:
distributing said plurality of signals from said train wireless signal receiving and distribution system to a plurality of passenger-users traveling on said train.

26. The method of claim 16 further comprising:
connecting a plurality of wireless access points to said train station wireless signal distribution system for transmitting said plurality of signals to said train from each of access points.

27. A method for transmitting wireless signals from a plurality of wireless access points (AP) to a train comprising:
connecting a high speed wide-area local area network (WLAN) switch between a network and a multiplexed Ethernet fiber system for receiving and transmitting a plurality of Internet signals to said plurality of wireless access points (AP).

28. The method of claim 27 further comprising:
implementing a wireless signal receiving and distribution system on said train for processing a roaming and handover from receiving said plurality of signals from one of said wireless access point to a next wireless access point.

29. The method of claim 27 further comprising:
distributing said plurality of signals to a plurality of passenger-users traveling on said train.

30. A method for transmitting a plurality of wireless signals to a train comprising:
implementing at least a first and a second train station wireless distribution systems for transmitting a plurality of wireless signals;
implementing a train wireless signal receiving and distribution system on a train for receiving said plurality of signals from at least one of said first and second train station wireless distribution systems; and
processing a handover from receiving said plurality of signals from a one of said first and second train station wireless distribution systems to another of said first and second train station wireless distribution systems.

31. A method of transmitting a plurality of wireless signals to a train comprising:
implementing at least a first and a second wireless access points for transmitting a plurality of wireless signals to said train;
implementing a train wireless signal receiving and distribution system disposed on a train for receiving said plurality of signals from at least one of said wireless access points; and
processing a handover from receiving said plurality of signals from a one of said wireless access to another of said wireless access points.
